(19) United States
(12) Patent Application Publication
(10) Pub. No.: US 2019/0205802 A1
(43) Pub. Date: Jul. 4, 2019

(54) INFORMATION PROCESSING DEVICE, INFORMATION PROCESSING METHOD AND COMPUTER READABLE MEDIUM

(71) Applicant: MITSUBISHI ELECTRIC CORPORATION, Tokyo (JP)

(72) Inventor: Kengo SHIRAKI, Tokyo (JP)

(73) Assignee: MITSUBISHI ELECTRIC CORPORATION, Tokyo (JP)

(21) Appl. No.: 16/325,336

(22) PCT Filed: Sep. 7, 2016
(86) PCT No.: PCT/JP2016/076317

§ 371 Date: Feb. 13, 2019

(51) Int. Cl. G06Q 10/06; G06Q 10/10

(52) U.S. Cl. CPC G06Q 10/0633; G06Q 10/1091

(57) ABSTRACT

A decreasing index value calculation unit (112) calculates for each of a plurality of workers, by using working-hour data wherein a history of working hours of the plurality of workers in a working process is indicated for each of the plurality of workers, a decreasing index value being an index value to represent a decreasing state in the working hours due to increase in the number of times of carrying out the working process. A learning easiness determination unit (107) determines, based on the decreasing index value of the plurality of workers, whether the working process is a working process easy to learn or not.

### TECHNICAL FIELD

The present invention relates to an information processing device, an information processing method and an information processing program.

### BACKGROUND ART

In factories, one product is produced through a plurality of working processes. One worker is hardly in charge of all of a plurality of working processes, and a plurality of workers often share a plurality of working processes. At this time, two or more workers may carry out the same working process in parallel.

Further, two or more workers may often share one working process on different working days.

Generally, a working procedure is specified for each working process and a standard time is set, the standard time being required for completion of work if the work is carried out in accordance with the working procedure. However, performance at a time of carrying out a work differs between respective workers. Further, the time taken for the work differs between an occasion in which a worker carries out the work for the first time, and an occasion in which the same worker has gotten used to the work through repeating the work.

Therefore, actual working hours actually taken for the work may largely differ from the standard time.

Patent Literature 1 discloses a system to calculate an estimated working hour in accordance with a cumulative number of times of carrying out a same working process, by using result data of working hours of workers. In the system of Patent Literature 1, by using the result data of working hours for an arbitrary working process, a learning curve representing a proficiency level of workers with respect to the working process is generated, and working hours after repeating the work is estimated by using the learning curve generated.

### CITATION LIST

### Patent Literature

Patent Literature 1: JP 2005-284415 A

### SUMMARY OF INVENTION

### Technical Problem

Among a plurality of working processes included in a production line in a factory, there are working processes which are difficult to learn and less prone to reduce the working hours even after repeating the work, and working processes which are easy to learn and prone to reduce the working hours. In terms of optimization of a work plan, it is desirable to develop a work plan after distinguishing the working processes which are difficult to learn from the working processes which are easy to learn.

The technique of Patent Literature 1 calculates estimated working hours for respective working processes; however, the technique of Patent Literature 1 does not determine whether the working processes are easy to learn or not. Therefore, there is a problem that a work manager who manages working processes cannot develop an optimum work plan after considering easiness to learn the working processes.

The present invention is mainly aimed at resolving such a problem. That is, the present invention is mainly aimed at obtaining a configuration to determine whether a working process is easy to learn or not.

### Solution to Problem

An information processing device according to the present invention, includes:

a decreasing index value calculation unit to calculate for each of a plurality of workers, by using working-hour data wherein a history of a working hour of the plurality of workers in a working process is indicated for each of the plurality of workers, a decreasing index value being an index value to represent a decreasing state in the working hour due to increase in the number of times of carrying out the working process, and;

a learning easiness determination unit to determine, based on the decreasing index value of the plurality of workers, whether the working process is a working process easy to learn or not.

### Advantageous Effects of Invention

According to the present invention, it is possible to determine whether it is easy to learn a working process.

### BRIEF DESCRIPTION OF DRAWINGS

FIG. 1 is a diagram illustrating an example of a system configuration according to a first embodiment;

FIG. 2 is a diagram illustrating an example of a hardware configuration of an information processing device according to the first embodiment;

FIG. 3 is a diagram illustrating an example of a functional configuration of the information processing device according to the first embodiment;

FIG. 4 is a diagram illustrating relation between a hardware configuration and a functional configuration of the information processing device according to the first embodiment;

FIG. 5 is a flowchart illustrating an operation example of the information processing device according to the first embodiment;

FIG. 6 is a diagram illustrating a learning curve according to the first embodiment;

FIG. 7 is a flowchart illustrating detail of a learning easiness determination process according to the first embodiment;

FIG. 8 is a flowchart illustrating detail of a learning ability determination process according to the first embodiment;

FIG. 9 is a diagram illustrating an example of a functional configuration of an information processing device according to a second embodiment; and

FIG. 10 is a diagram illustrating an example of an upper limit curve and a lower limit curve according to the second embodiment.

### DESCRIPTION OF EMBODIMENTS

Hereinbelow, embodiments of the present invention will be described with use of the drawings. In following description and the drawings on the embodiments, elements provided with identical reference characters represent identical elements or corresponding elements.

### First Embodiment

***Explanation of Configuration***

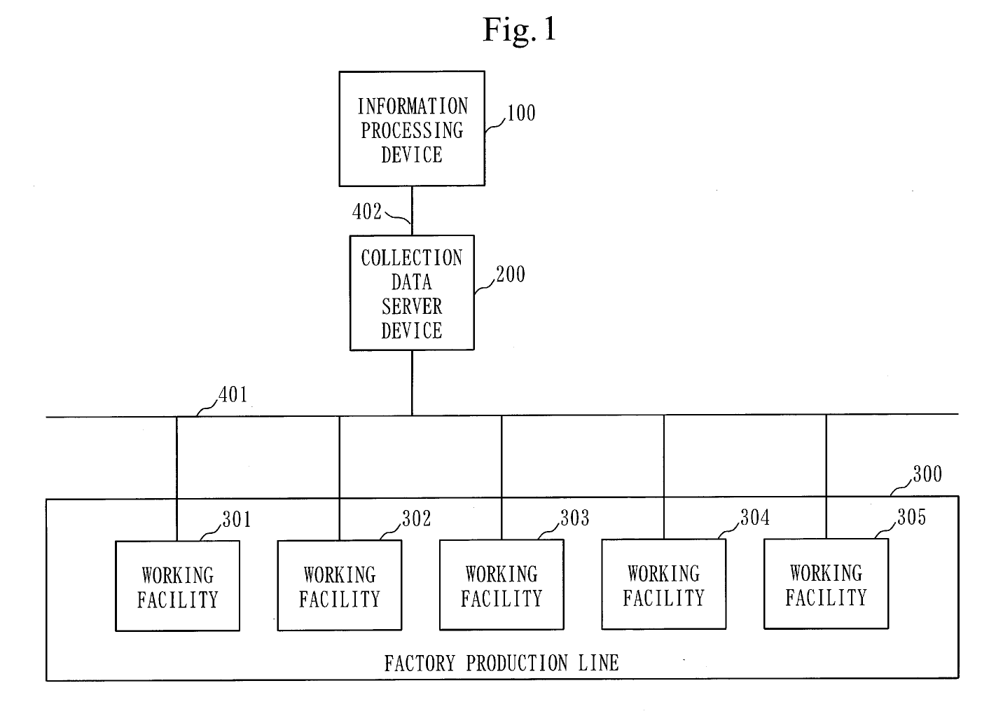

FIG. 1 illustrates an example of a system configuration according to the present embodiment.

The system according to the present embodiment is configured by an information processing device 100, a collection data server device 200 and a factory production line 300. In the factory production line 300, working facilities 301 through 305 exist.

In the present embodiment, working processes correspond to the working facilities 301 through 305.

That is, in the present embodiment, there are five working processes of a working process using the working facility 301, a working process using the working facility 302, a working process using the working facility 303, a working process using the working facility 304 and a working process using the working facility 305, in the factory production line 300.

Hereinafter, the working process using the working facility 301 is called a working process 1. Further, the working process using the working facility 302 is called a working process 2. Furthermore, the working process using the working facility 303 is called a working process 3. The working process using the working facility 304 is called a working process 4. The working process using the working facility 305 is called a working process 5.

Further, in the present embodiment, the respective working processes are carried out by a plurality of workers. However, combination of workers and the number of workers in the respective working processes may differ.

Furthermore, in the present embodiment, respective workers are in charge of one or more working processes. A worker who is in charge of only one working process may exist; however, workers of at least a half of the number of all the workers are in charge of two or more working processes.

The information processing device 100 determines easiness to learn working processes by using working-hour data collected by the collection data server device 200. Further, the information processing device 100 determines learning ability of workers.

The working-hour data is data indicating a history of working hours on a worker-by-worker basis for respective working processes.

The information processing device 100 is connected to the collection data server device 200 via a network 402.

The operations performed by the information processing device 100 correspond to an information processing method and an information processing program.

The collection data server device 200 collects working-hour data from the factory production line 300. There may be any methods to collect the working-hour data by the collection data server device 200.

The collection data server device 200 is connected to the working facilities 301 through 305 via a network 401.

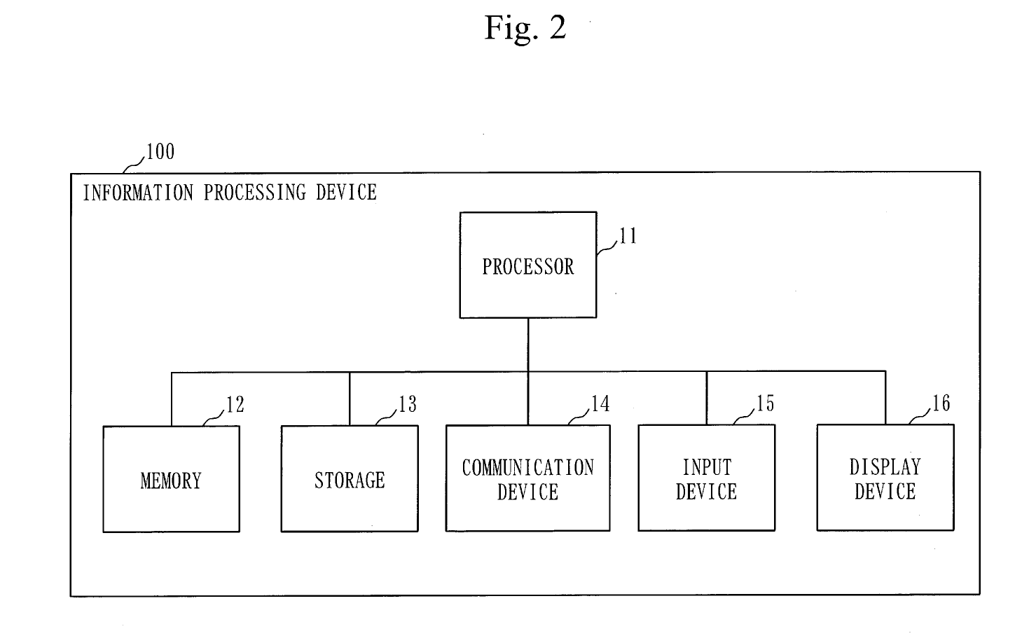

FIG. 2 illustrates an example of a hardware configuration of the information processing device 100.

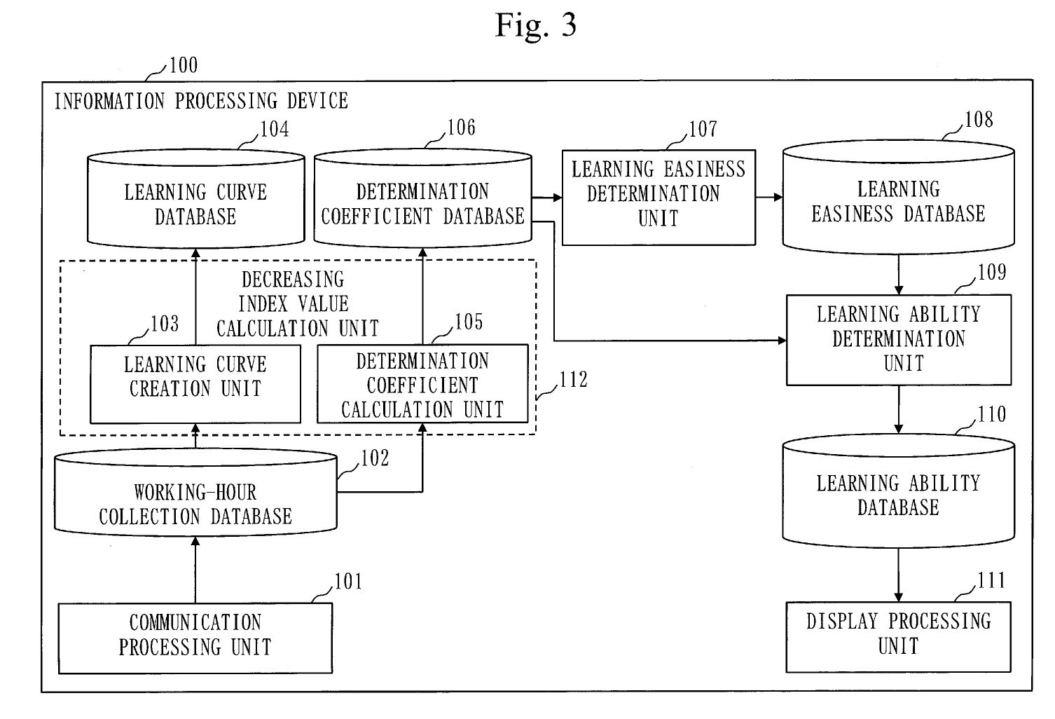

FIG. 3 illustrates an example of a functional configuration of the information processing device 100.

First, with reference to FIG. 2, the example of the hardware configuration of the information processing device 100 is described.

The information processing device 100 is a computer.

The information processing device 100 is equipped with a processor 11, a memory 12, a storage 13, a communication device 14, an input device 15 and a display device 16, as hardware.

The storage 13 stores programs to realize functions of a communication processing unit 101, a learning curve creation unit 103, a determination coefficient calculation unit 105, a learning easiness determination unit 107, a learning ability determination unit 109 and a display processing unit 111 illustrated in FIG. 3.

Then, these programs are loaded into the memory 12, and the processor 11 executes these programs.

Further, the storage 13 realizes a working-hour collection database 102, a learning curve database 104, a determination coefficient database 106, a learning easiness database 108 and a learning ability database 110 illustrated in FIG. 3.

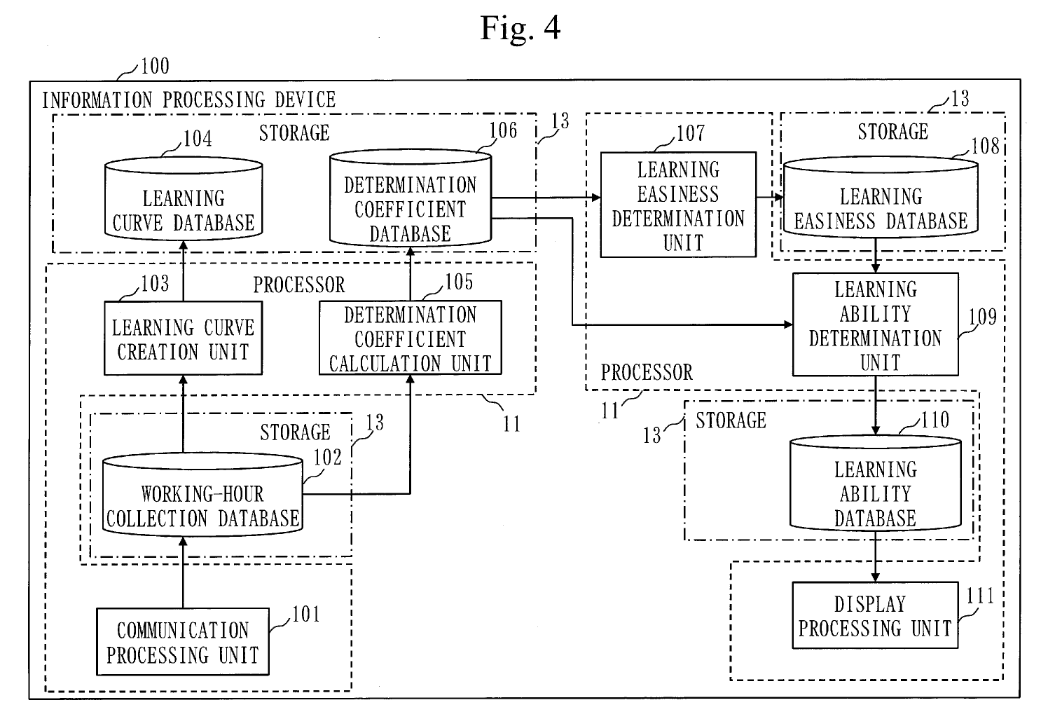

FIG. 4 illustrates the relation between the hardware configuration of FIG. 2 and the functional configuration of FIG. 3.

That is, FIG. 4 schematically denotes a state wherein the processor 11 executes the programs to realize the functions of the communication processing unit 101, the learning curve creation unit 103, the determination coefficient calculation unit 105, the learning easiness determination unit 107, the learning ability determination unit 109 and the display processing unit 111. Further, FIG. 4 schematically denotes a state wherein the storage 13 is used as the working-hour collection database 102, the learning curve database 104, the determination coefficient database 106, the learning easiness database 108 and the learning ability database 110. Note that at least a part of the working-hour collection database 102, the learning curve database 104, the determination coefficient database 106, the learning easiness database 108 and the learning ability database 110 may be realized by the memory 12.

Next, with reference to FIG. 3, an example of the functional configuration of the information processing device 100 is described.

The communication processing unit 101 receives working-hour data from the collection data server device 200, by using the communication device 14.

Further, the communication processing unit 101 stores the working-hour data received in the working-hour collection database 102.

The learning curve creation unit 103 creates learning curves on a worker-by-worker basis for respective working processes by using the working-hour data stored in the working-hour collection database 102. The learning curve is a curve indicating relation between the number times of carrying out a working process and working hours in the working process. Then, the learning curve creation unit 103 stores learning curve data describing the learning curves created in the learning curve database 104.

The determination coefficient calculation unit 105 calculates determination coefficients between the learning curves created by the learning curve creation unit 103 and the histories of working hours indicated in the working-hour data. Further, the determination coefficient calculation unit 105 stores determination coefficient data describing the determination coefficients calculated in the determination coefficient database 106. A determination coefficient is an index value to represent a decreasing state in working hours due to increase in the number of carrying out, and corresponds to a decreasing index value.

Note that the learning curve creation unit 103 and the determination coefficient calculation unit 105 may be also called a decreasing index value calculation unit 112. Further, the operation of the learning curve creation unit 103 and the determination coefficient calculation unit 105 corresponds to a decreasing index value calculation process.

The learning easiness determination unit 107 determines whether each working process is a working process easy to learn based on the determination coefficients (decreasing index values) of a plurality of workers. More specifically, the learning easiness determination unit 107 selects a determination coefficient that matches a selection condition from among the determination coefficients of the plurality of workers. Then, the learning easiness determination unit 107 calculates a mean value of the determination coefficients selected, and when the mean value calculated is equal to or more than a threshold value, determines the corresponding working process as a working process easy to learn.

Furthermore, the learning easiness determination unit 107 stores learning easiness data describing determination results regarding each working process in the learning easiness database 108.

Note that the operation of the learning easiness determination unit 107 corresponds to a learning easiness determination process.

The learning ability determination unit 109 determines a learning ability of each worker using the determination coefficients of the working processes that are determined by the learning easiness determination unit 107 as working processes easy to learn. More specifically, the learning ability determination unit 109 calculates, for each worker, a mean value of the determination coefficients of the working processes that are determined by the learning easiness determination unit 107 as the working processes easy to learn. Then, when the mean value calculated is equal to or more than a threshold value, the learning ability determination unit 109 determines that the corresponding worker has a requested learning ability. Meanwhile, when the mean value calculated is less than the threshold value, the learning ability determination unit 109 determines that the corresponding worker does not have a requested learning ability.

Further, the learning ability determination unit 109 stores worker-learning-ability data describing determination results regarding respective workers in a worker-learning-ability database 110.

The display processing unit 111 displays the determination results of the learning ability determination unit 109 on the display device 16. For example, the display processing unit 111 displays on the display device 16 a worker who is determined as not having a requested learning ability.

***Explanation of Operation***

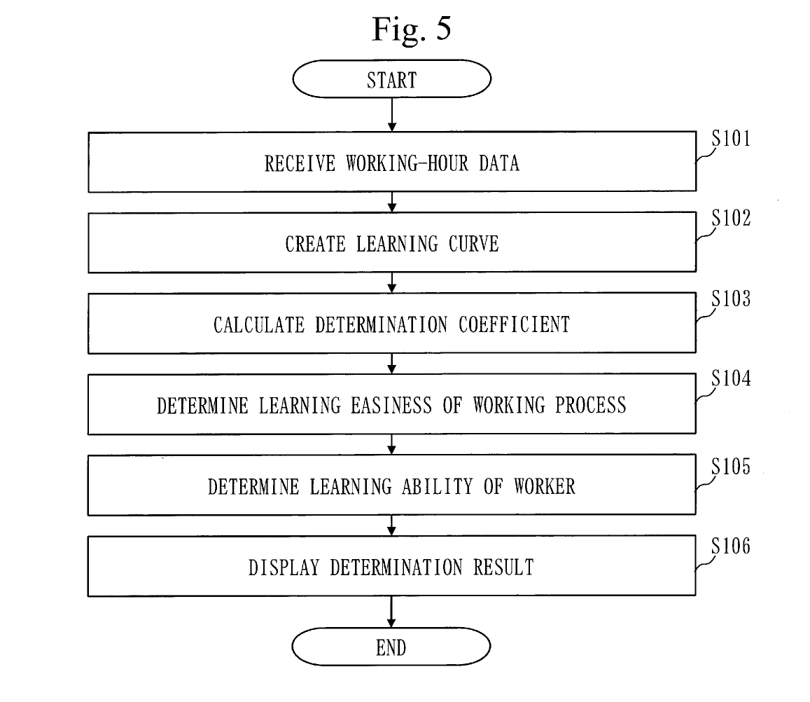

Next, with reference to a flowchart in FIG. 5, explanation is provided of an example of the operation of the information processing device 100 according to the present embodiment.

In a step S101, the communication processing unit 101 receives working-hour data from the collection data server device 200 via the communication device 14. Further, the communication processing unit 101 stores the working-hour data received in the working-hour collection database 102.

In the working-hour data, a worker name, a working process, a work start time, a work finish time, a cumulative number of times of carrying out the working process are described.

Next, in a step S102, the learning curve creation unit 103 creates learning curves on a worker-by-worker basis for respective working processes using the working-hour data. For example, when a worker A is in charge of a working process 1 and a working process 2, the learning curve creation unit 103 creates a learning curve of the worker A with respect to the working process 1, and a learning curve of the worker A with respect to the working process 2. The learning curve creation unit 103 stores the learning curve data describing the learning curves created in the learning curve database 104.

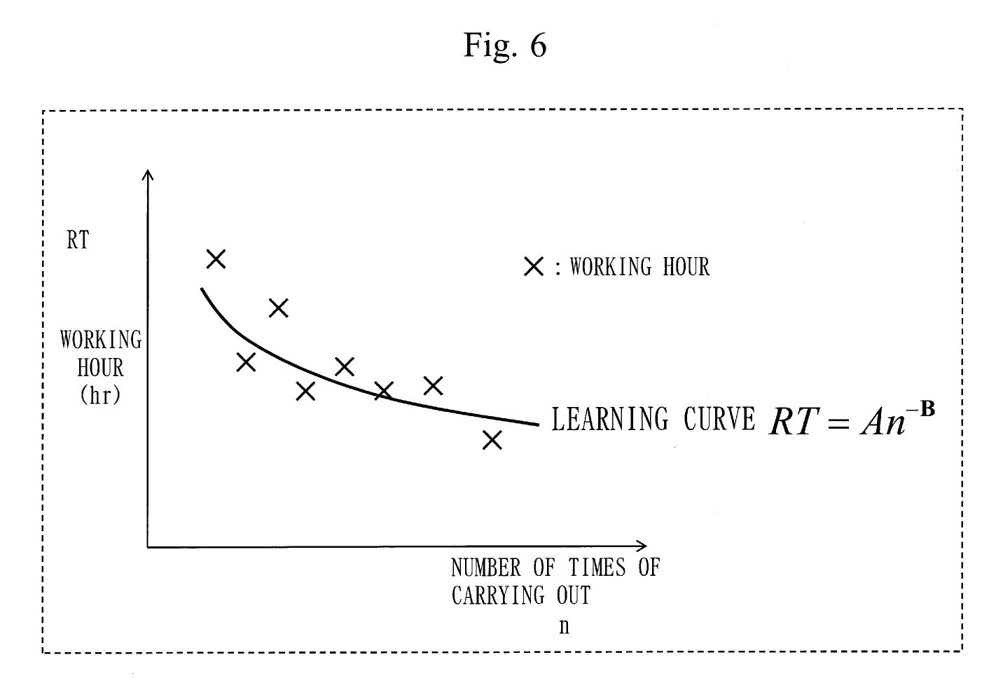

FIG. 6 illustrates an example of the learning curve. Since workers generally get used to a work by repeating a same working process, working hours tend to decrease as the number of times of carrying out increases. Also in the example of FIG. 6, a working hour RT decreases as the number of times of carrying out n increases.

The decreasing tendency of working hours is approximated by an expression (1). In the expression (1), RT is working hours required until work completion, and n is the number of times of carrying out a working process.

[Formula 1]

RT=An^{-B} Expression (1)

Further, A and B in the expression (1) are variables obtained by following expressions (2) and (3).

In the following, n denotes the number of times of carrying out, N denotes a cumulative number of carrying out, n- (n with - above) denotes a mean value of the cumulative number of carrying out, RTₙ denotes working hours at the time when the n-th work is carried out, and RT- (RT with - above) denotes a mean value of working hours of all number of times of carrying out.

$$\begin{matrix}[ Formula 2 ] & \\ A = \frac{{\sum }_{n = 1}^{N} ( n - \overline{n} ) ( {RT}_{n} - \overline{RT} )}{{\sum }_{n = 1}^{N} {( n - \overline{n} )}^{2}} & Expression ( 2 ) \\ B = {exp ( \overline{RT} - A \overline{n} )}^{2} & Expression ( 3 )\end{matrix}$$

In a step S103, the determination coefficient calculation unit 105 calculates a determination coefficient. More specifically, the determination coefficient calculation unit 105 collates a learning curve created in the step S102 with the history of working hours indicated in working-hour data of the corresponding working process and the corresponding worker, and calculates a determination coefficient R². Further, the determination coefficient calculation unit 105 stores determination coefficient data describing the determination coefficient R² calculated in the determination coefficient database 106.

For example, the determination coefficient calculation unit 105 collates a learning curve of the worker A with respect to the working process 1 with a history of working hours indicated in working-hour data of the worker A with respect to the working process 1, and calculates the determination coefficient R².

The determination coefficient R² is an index indicating a degree of relevance between a learning curve and an actual working hour, taking a value of [0, 1]. The degree of relevance of the learning curve to the actual working hour becomes larger as the determination coefficient becomes closer to 1, and becomes smaller as the determination coefficient becomes closer to 0. The determination coefficient R² is obtained by an expression (4).

$$\begin{matrix}[ Formula 3 ] & \\ {R}^{2} = \frac{{( {\sum }_{n = 1}^{N} ( n - \overline{n} ) ( {RT}_{n} - \overline{RT} ) )}^{2}}{{\sum }_{n = 1}^{N} {( n - \overline{n} )}^{2} {\sum }_{n = 1}^{N} {( {RT}_{n} - \overline{RT} )}^{2}} & Expression ( 4 )\end{matrix}$$

In a step S104, the learning easiness determination unit 107 determines easiness to learn (learning easiness) for each working process, by using the determination coefficient R². Further, the learning easiness determination unit 107 stores learning easiness data describing determination results in the learning easiness database 108.

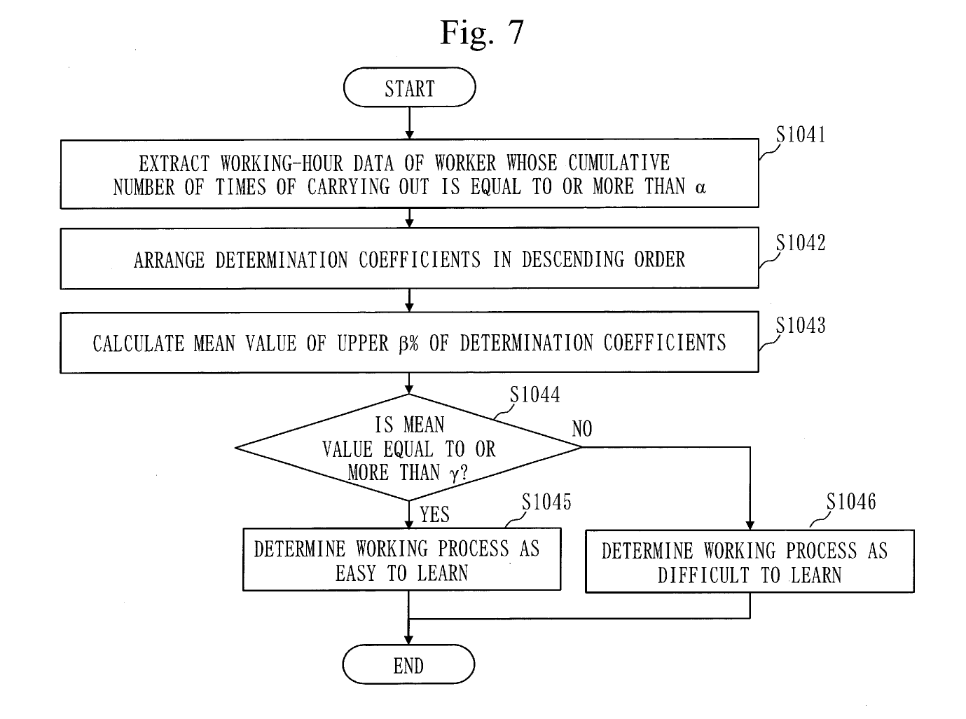

Specifically, the learning easiness determination unit 107 determines easiness to learn of each working process, according to the procedure described in FIG. 7. The learning easiness determination unit 107 repeats the procedure described in FIG. 7, and determines easiness to learn for each of the working processes 1 to 5.

It is assumed that concrete numerical values of α, β and γ indicated in FIG. 7 are set by a work manager. Hereinafter, each step in FIG. 7 is described.

First, the learning easiness determination unit 107 extracts working-hour data of a worker whose cumulative number of times of carrying out is equal to or more than α times (step S1041), about a working process which is an object of determination on learning easiness.

At a stage wherein a cumulative number of times of carrying out is small, since a worker is not familiar with the work, the working hours vary greatly. Therefore, there is a possibility of not being able to determine learning easiness of working processes accurately, when using working-hour data of a worker whose cumulative number of times of carrying out is small. Accordingly, the learning easiness determination unit 107 only uses working-hour data of workers whose cumulative number of times of carrying out is equal to or more than a fixed number (α times) for determination on learning easiness of a working process.

Next, the learning easiness determination unit 107 arranges determination coefficients of workers whose working-hour data is extracted in the step S1041 in descending order (step S1042).

Next, the learning easiness determination unit 107 calculates a mean value of determination coefficients in the top β % of the determination coefficients arranged in the step S1042 (step S1043). Further, the learning easiness determination unit 107 handles the mean value of the determination coefficients in the top β % as learning easiness of each working process.

A worker with low determination coefficient of a certain working process often has poor learning ability in all working processes. Therefore, there is a possibility of not being able to determine learning easiness of working processes accurately, when using determination coefficients of low values. Thus, the learning easiness determination unit 107 uses the top β % of the determination coefficients as an index of learning easiness.

Next, the learning easiness determination unit 107 determines whether the mean value calculated in the step S1043 is equal to or more than a threshold value γ (step S1044).

The learning easiness determination unit 107 determines working processes whose mean value is equal to or more than the threshold value γ as working processes easy to learn (step S1045). Meanwhile, the learning easiness determination unit 107 determines working processes whose mean value is less than the threshold value γ as working processes difficult to learn (step S1046).

Returning to the flowchart in FIG. 5, in a step S105, the learning ability determination unit 109 determines learning ability of each worker. Further, the learning ability determination unit 109 stores learning ability data describing determination results in the learning ability database 110.

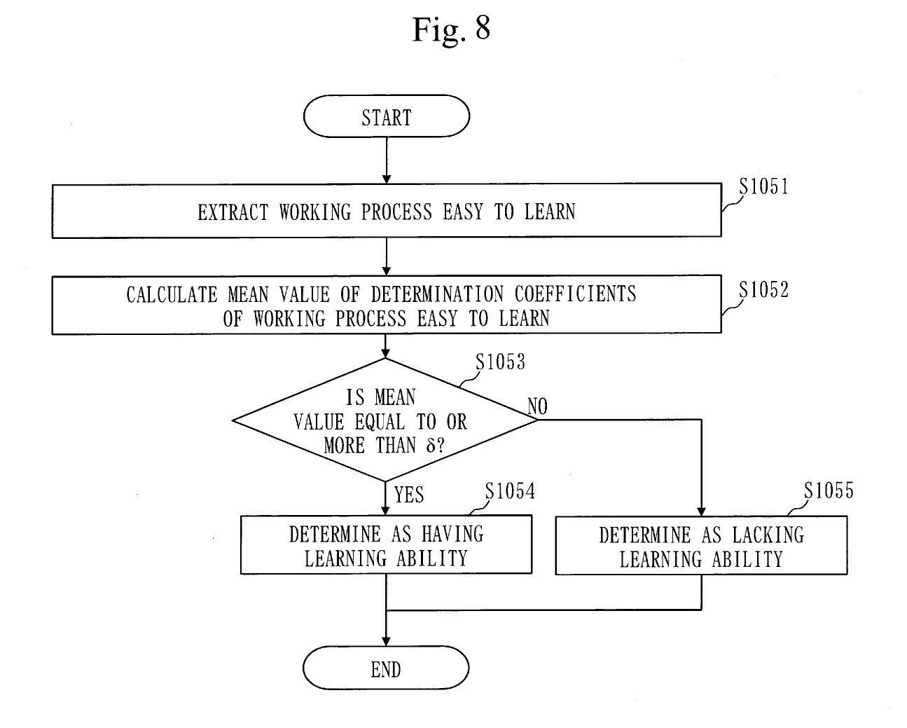

Specifically, the learning ability determination unit 109 determines learning ability of each worker according to the procedure illustrated in FIG. 8. It is assumed that a specific numerical value of δ illustrated in FIG. 8 is set by a work manager. Hereinafter, each step in FIG. 8 is described.

First, the learning ability determination unit 109 extracts working processes (hereinafter called working processes easy to learn) determined to be easy to learn in the step S1045 (step S1051).

The working process determined to be difficult to learn is difficult to learn even when a worker having high learning ability handles, and determination coefficient is low. There is a possibility of not being able to determine learning ability of workers accurately when using determination coefficients of working processes determined to be difficult to learn. Therefore, the learning ability determination unit 109 extracts working processes which are easy to learn.

Next, the learning ability determination unit 109 calculates, for each worker, a mean value of the determination coefficients of the working processes easy to learn, which are extracted in the step S1051 (step S1052). The learning ability determination unit 109 handles the mean value calculated as learning ability of each worker.

For example, it is supposed a case wherein the worker A is in charge of the working process 1 and the working process 2, and a worker B is in charge of the working process 2 and the working process 3. If the working processes 1, 2 and 3 are working processes that are easy to learn, as for the worker A, the learning ability determination unit 109 calculates a mean value of a determination coefficient with respect to the working process 1 and a determination coefficient with respect to the working process 2. Further, as for the worker B, the learning ability determination unit 109 calculates a mean value of a determination coefficient with respect to the working process 2 and a determination coefficient with respect to the working process 3.

Next, the learning ability determination unit 109 determines whether the mean value calculated in the step S1052 is equal to or more than a threshold value δ for each worker (step S1053).

The learning ability determination unit 109 determines a worker whose mean value is equal to or more than the threshold value δ as a worker having learning ability (step S1054).

Meanwhile, the learning ability determination unit 109 determines a worker whose mean value is less than δ as a worker lacking learning ability (step S1055).

Returning to the flowchart in FIG. 5, in a step S106, the display processing unit 111 displays determination results of the learning ability determination unit 109 on the display device 16.

In order to proceed production works smoothly, a work manager in a production site needs to grasp working ability of each worker. Therefore, the display processing unit 111 displays a worker determined to lack learning ability in the step S1055 on the display device 16, and notifies the work manager of the worker lacking the learning ability.

Further, it may be applicable to make the display processing unit 111 display on the display device 16 the determination results of the learning easiness determination unit 107, i.e., leaning easiness of each working process.

***Explanation of Effect of Embodiment***

According to the present embodiment, it is possible to determine whether each working process is easy to learn or not. Therefore, a work manager can make an optimal work plan in consideration of leaning easiness of each working process.

Further, according to the present embodiment, it is possible to determine presence or absence of learning ability for each worker. Therefore, the work manager can make an optimal work plan in consideration of the learning ability of each worker.

### Second Embodiment

In the first embodiment, as a determination index, only determination coefficients are used in determination processing of the learning ability of workers in the step S1053 of FIG. 8.

In the present embodiment, by using a learning curve created in the step S102 of FIG. 5 as a determination index in addition to determination coefficients, determination precision in determination of the learning ability of workers is enhanced.

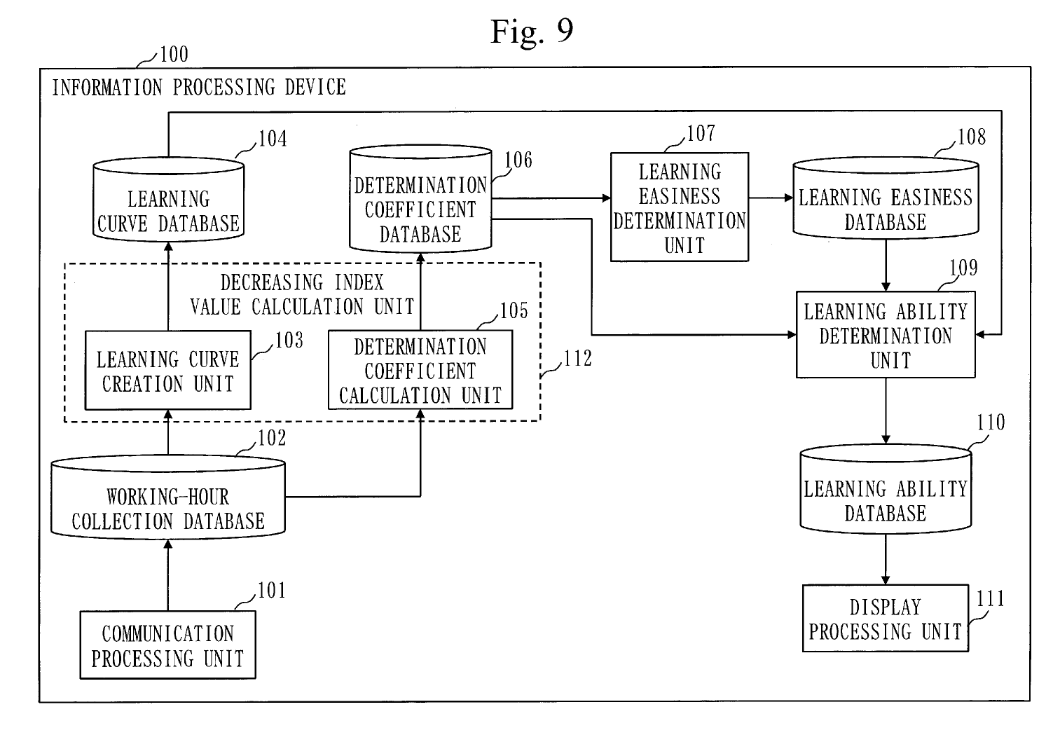

FIG. 9 illustrates an example of a functional configuration of the information processing device 100 according to the present embodiment.

FIG. 9 is different from FIG. 3 in that the learning ability determination unit 109 obtains a learning curve from the learning curve database 104. Note that the other elements in FIG. 9 are the same as those illustrated in FIG. 3; hence, the explanation is omitted. Further, an example of a hardware configuration of the information processing device 100 according to the present embodiment is the same as that illustrated in FIG. 2.

Hereinafter, explanation is mainly provided of difference from the first embodiment. The items not explained below are the same as those in the first embodiment.

In the present embodiment, the learning ability determination unit 109 uses determination coefficients and a learning curve to determine learning ability of a worker. The learning ability determination unit 109 identifies as those having learning ability, only workers who are determined to have learning ability in both of evaluation using the determination coefficients and evaluation using the learning curve.

Since the evaluation using the determination coefficients is the same as that described in the first embodiment, the explanation is omitted.

In the present embodiment, the learning ability determination unit 109 uses the learning curve in the following manner to evaluate the learning ability of workers.

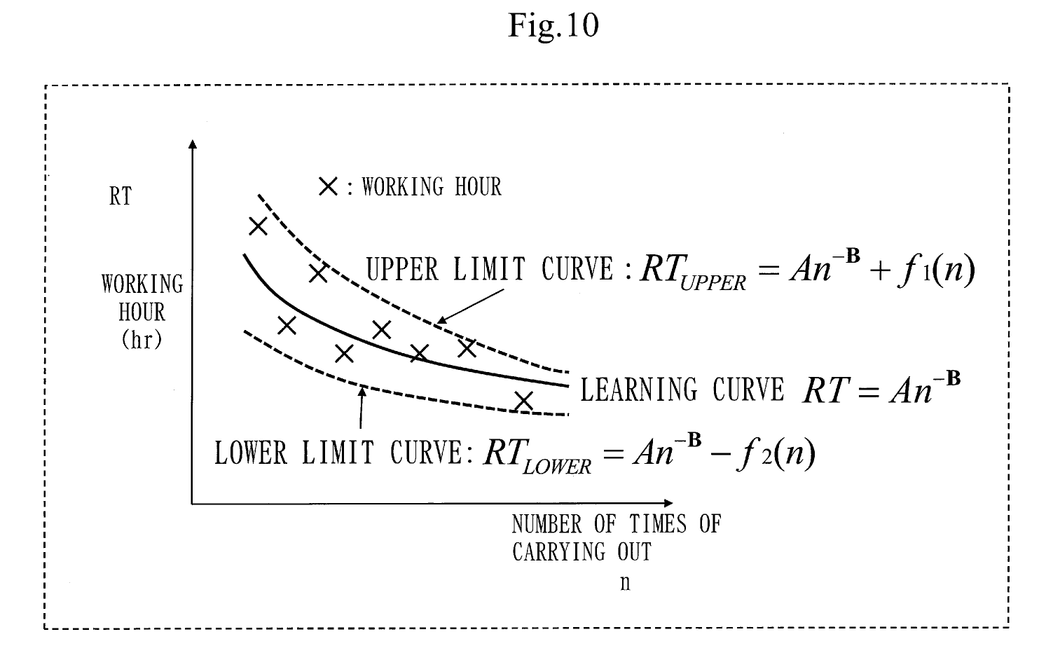

The learning ability determination unit 109 sets an upper limit curve being a curve of an upper limit of working hours, and a lower limit curve being a curve of a lower limit of working hours along a learning curve of a working process determined to be a working process easy to learn by the learning easiness determination unit 107. That is, the learning ability determination unit 109 calculates an upper limit and a lower limit of an allowable range of working hours for respective number of times of carrying out, and sets the upper limit curve and the lower limit curve. FIG. 10 illustrates an example of a learning curve wherein the upper limit curve and the lower limit curve are set.

The upper and lower limits of the allowable range for each of number of times of carrying out are calculated by an expression (5) and an expression (6), respectively, based on the learning curve of the corresponding working process.

[Formula 4]

UPPER LIMIT: RT_{UPPER}=An^{-B}+f₁(n) Expression (5)

LOWER LIMIT: RT_{LOWER}=An^{-B}−f₂(n) Expression (6)

Functions f₁(n) and f₂(n) to specify the upper and lower limits of the allowable range are set by a work manager. The functions f₁(n) and f₂(n) are, for example, expressed by an expression (7) wherein a width of the upper and lower limits of the learning curve is decreased to be narrower as the number of times of carrying out is accumulated.

[Formula 5]

f(n)=RT/n Expression (7)

The learning ability determination unit 109 uses deviation between the upper/lower limits of the allowable range of the working hours and actual working hours for determination of the learning ability of workers. That is, the learning ability determination unit 109 compares a history of working hours indicated in working-hour data with the upper limit curve and the lower limit curve of the learning curve, and determines the learning ability of workers.

The learning ability determination unit 109 determines a worker as lacking learning ability when any of the following conditions is satisfied.

a) at a stage wherein a cumulative number of times of carrying out is not more than five, the number of times working hours in the working-hour data deviates from the upper limit or the lower limit is equal to or more than three
b) at a stage wherein a cumulative number of times of carrying out exceeds five, working hours in the working-hour data deviate from the upper limit or the lower limit for three times consecutively.

Note that a worker does not necessarily lack learning ability when the working hours in the working-hour data deviate from the lower limit. However, when working hours in the working-hour data deviate from the lower limit for a plurality of times, there is a possibility that a problem exists such that the worker does not carry out a part of work procedure. Therefore, when working hours of a certain worker deviate from the lower limit for a specified number of times or more, in order to attract attention of a work manager, the learning ability determination unit 109 determines that such worker lacks the learning ability, and makes the display processing unit 111 present such worker to the work manager.

As described above, according to the present embodiment, in determination of learning ability of workers, highly accurate determination is possible since deviation from upper and lower limits of a learning curve of working hours is considered in addition to determination coefficients.

The above explains the embodiments of the present invention; however, two or more of these embodiments may be performed in combination.

Meanwhile, one of these embodiments may be partially performed.

Otherwise, two or more of these embodiments may be performed by partially combining the same.

Note that the present invention is not limited to these embodiments, and various alterations can be made as required.

***Explanation of Hardware Configuration***

Lastly, a supplementary explanation of the hardware configuration of the information processing device 100 will be provided.

The processor 11 illustrated in FIG. 2 is an integrated circuit (IC) that performs processing.

For example, the processor 11 is a central processing unit (CPU), a digital signal processor (DSP), etc.

The memory 12 illustrated in FIG. 2 is, for example, a random access memory (RAM).

The storage 13 illustrated in FIG. 2 is, for example, a read only memory (ROM), a flash memory, a hard disk drive (HDD), etc.

The communication device 14 illustrated in FIG. 2 includes a receiver to receive data, and a transmitter to transmit data.

The communication device 14 is, for example, a communication chip or a network interface card (NIC).

The input device 15 is, for example, a mouse or a keyboard.

The display device 16 is, for example, a display.

The storage 13 also stores an operating system (OS).

Then, at least part of the OS is loaded into the memory 12, and executed by the processor 11.

The processor 11 executes the programs to realize the functions of the communication processing unit 101, the learning curve creation unit 103, the determination coefficient calculation unit 105, the learning easiness determination unit 107, the learning ability determination unit 109 and the display processing unit 111 while executing at least part of the OS.

With the processor 11 executing the OS, task management, memory management, file management, communication control, etc. are performed.

Further, information, data, signal values or variable values indicating the results of the processing by the communication processing unit 101, the learning curve creation unit 103, the determination coefficient calculation unit 105, the learning easiness determination unit 107, the learning ability determination unit 109 and the display processing unit 111 are stored in at least any of the memory 12, the storage 13, or a register or a cache memory in the processor 11.

Further, the programs to realize the functions of the communication processing unit 101, the learning curve creation unit 103, the determination coefficient calculation unit 105, the learning easiness determination unit 107, the learning ability determination unit 109 and the display processing unit 111 may be stored in a portable recording medium such as a magnetic disk, a flexible disk, an optical disc, a compact disk, a blue-ray (registered trademark) disc, a DVD, etc.

Furthermore, the “units” of the communication processing unit 101, the learning curve creation unit 103, the determination coefficient calculation unit 105, the learning easiness determination unit 107, the learning ability determination unit 109 and the display processing unit 111 may be read as “circuits,” “steps,” “procedures” or “processing.”

Further, the information processing device 100 may be realized by electronic circuits such as a logic integrated circuits (logic IC), a gate array (GA), an application specific integrated circuit (ASIC) or a field-programmable gate array (FPGA), etc.

The processor and the electronic circuit as described above are collectively referred to as “processing circuitry”.

### REFERENCE SIGNS LIST

100: information processing device; 101: communication processing unit; 102: working-hour collection database; 103: learning curve creation unit; 104: learning curve database; 105: determination coefficient calculation unit; 106: determination coefficient database; 107: learning easiness determination unit; 108: learning easiness database; 109: learning ability determination unit; 110: learning ability database; 111: display processing unit; 112: decreasing index value calculation unit; 200: collection data server device; 300: factory production line; 301: working facility; 302: working facility; 303: working facility; 304: working facility; 305: working facility; 401: network; 402: network

1. An information processing device comprising:
processing circuitry to:
calculate for each of a plurality of workers, by using working-hour data wherein a history of a working hour of the plurality of workers in a working process is indicated for each of the plurality of workers, a decreasing index value being an index value to represent a decreasing state in the working hour due to increase in the number of times of carrying out the working process; and
determine, based on the decreasing index value of the plurality of workers, whether the working process is a working process easy to learn or not.

2. The information processing device as defined in claim 1,
wherein the processing circuitry selects a decreasing index value that matches a selection condition from among decreasing index values of the plurality of workers, calculates a mean value of the decreasing index value selected, and when the mean value calculated is equal to or more than a threshold value, determines the working process as the working process easy to learn.

3. The information processing device as defined in claim 1,
wherein the processing circuitry calculates, by using working-hour data wherein a history of a working hour of each of the plurality of workers in a plurality of working processes is indicated, the decreasing index value on a worker-by-worker basis for each of the plurality of working processes,
determines, based on the decreasing index values of the plurality of workers, whether each of the plurality of working processes is the working process easy to learn or not, and
determines, by using a decreasing index value of the working process that is determined to be the working process easy to learn, learning ability of each of the plurality of workers.

4. The information processing device as defined in claim 3,
wherein the processing circuitry calculates a mean value of the decreasing index value of the working process that is determined to be the working process easy to learn, for each of the plurality of workers,
determines, when the mean value calculated is equal to or more than a threshold value, that a corresponding worker has the learning ability required, and
determines, when the mean value calculated is less than the threshold value, that the corresponding worker does not have the learning ability required.

5. The information processing device as defined in claim 1,
wherein the processing circuitry generates, for each of the plurality of workers, by using the working-hour data, a learning curve which indicates a relation between the number of times of carrying out the working process and the working hour in the working process, and calculates a determination coefficient between the learning curve and the history of the working hour indicated in the working-hour data, as the decreasing index value.

6. The information processing device as defined in claim 5,
wherein the processing circuitry performs, by using the working-hour data wherein the history of each of the working hour of the plurality of workers in the plurality of working processes is indicated, generation of the learning curve and calculation of the determination coefficient on a worker-by-worker basis for each of the plurality of working processes,
determines, based on the determination coefficient of the plurality of workers, whether each of the working processes is the working process easy to learn or not, and
determines, by using a determination coefficient of the working process that is determined to be the working process easy to learn, learning ability of each of the plurality of workers.

7. The information processing device as defined in claim 6,
wherein the processing circuitry calculates a mean value of the determination coefficient of the working process that is determined to be the working process easy to learn, for each of the plurality of workers,
sets an upper limit curve being a curve of an upper limit of the working hour and a lower limit curve being a curve of a lower limit of the working hour along the learning curve of the working process that is determined to be the working process easy to learn, for each of the plurality of workers, and
determines the learning ability by performing comparison between the mean value calculated and the threshold value and comparison between the history of the working hour indicated in the working-hour data and the upper limit curve and the lower limit curve.

8. An information processing method comprising:
calculating for each of a plurality of workers, by using working-hour data wherein a history of a working hour of the plurality of workers in a working process is indicated for each of the plurality of workers, a decreasing index value being an index value to represent a decreasing state in the working hour due to increase in the number of times of carrying out the working process; and
determining, based on the decreasing index value of the plurality of workers, whether the working process is a working process easy to learn or not.

9. A non-transitory computer readable medium storing an information processing program that causes a computer to execute:
a decreasing index value calculation process to calculate for each of a plurality of workers, by using working-hour data wherein a history of a working hour of the plurality of workers in a working process is indicated for each of the plurality of workers, a decreasing index value being an index value to represent a decreasing state in the working hour due to increase in the number of times of carrying out the working process; and
a learning easiness determination process to determine, based on the decreasing index value of the plurality of workers, whether the working process is a working process easy to learn or not.
